(19) United States
(12) Patent Application Publication
(10) Pub. No.: US 2022/0234061 A1
(43) Pub. Date: Jul. 28, 2022

(54) System For Painting And Coating of Pipelines, Commercial, and Industrial Equipment

(71) Applicant: 1901543 Alberta Ltd., Edmonton (CA)

(72) Inventors: Damon Clifford Stewart, Sherwood Park (CA); Dean Stewart Hansen, Edmonton (CA)

(21) Appl. No.: 17/693,726

(22) Filed: Mar. 14, 2022

Related U.S. Application Data
(63) Continuation-in-part of application No. 16/848,365, filed on Apr. 14, 2020, now abandoned.
(60) Provisional application No. 62/833,901, filed on Apr. 15, 2019.

(51) Int. Cl. B05B 9/04; B05B 9/00

(52) U.S. Cl. CPC B05B 9/04; B05B 9/002

(57) ABSTRACT

A tankless system is provided for use with one or more cartridge-style spray guns for coating pipelines and equipment in remote outdoor locations. The system includes a system case sized to fit into a back of a pickup truck. The system case includes an insulated and heated cartridge container for storing one or more coating or paint cartridges, an independent power source, an independent source of compressed air and a control panel to control power to the system, control and monitor temperature of the cartridge container and control and monitor operation of the source of compressed air. The system is tankless and all coating and paint is provided to the cartridge-style spray guns by the cartridges. A method is also provided for performing painting and coating operations in a remote site using cartridge-style spray guns.

### FIELD

The present disclosure relates to an automated or semi-automated system for storage, transport and use of paints and plural component coatings.

### BACKGROUND

Spray coating or painting of pipes, pipelines, commercial and industrial equipment collectively called equipment, is required to prevent corrosion and potential damage or breach of such equipment. While some equipment is coated for use below ground, painting and coating can also be required for above grade equipment.

In both cases, the paints and coating consumables are commonly required to be kept at a minimum temperature for proper use, and in colder ambient applications may require on site heating.

While painting and coating of lengths of sections of pipe and parts of equipment may be done in a painting/coating facility, typically weld seams in the pipeline, as well as any parts of equipment assembled on site must be also painted or coated in the outdoors, at remote locations where the work is taking place. As well, in a case where a pipeline or commercial and industrial equipment is field welded or needs to be replaced or repaired, outdoor, onsite painting and/or coating is again required.

Traditionally, a spray bundle that includes spray lines, heat lines, mixing block and spray gun used for painting and coating were supplied with coating and painting consumables from large tanks or vats of each coating component. These must be transported out to site and heated by a heating line that is either electrical or a heating fluid like glycol, in which case a source of glycol must also be provided on site. The heated coating components are then pumped in separate lines with compressed air for atomizing at the spray gun, also flowing in a separate line. All of the lines are contained in a large sheath with the approximate weight of 200 lbs which ends at a nozzle. The substrate to be coated is often not in proximity of all of the coating equipment and can be up to 100 ft away. To keep the coating components at the required temperature, the hose also includes either an electrical or glycol heating line to the nozzle—hence 4-6 or more separate lines (component lines, heating lines, flush lines, return lines) are all contained in the sheath. The weight of these hoses is often such that multiple operators are required to carry and support them. A power source or generator is also required to power pumps to pump the painting and coating consumables from vats through the component lines, to power an air compressor to supply compressed air, and to provide heating to the vats and hose.

Until now, the equipment needed for plural component coating has been significantly large and cumbersome and is hence typically hauled on 5-10-ton trucks. The number of operators needed for an on-site painting coating job is typically 4-6. While the size of equipment and manpower requirements may be suitable for very large coating jobs, the current set up is oversized for smaller jobs such as only coating a welded pipe joint, field weld or a repaired surface of substrate.

To avoid the use of traditional equipment on small repair jobs, painting or coating is performed by manual brushing or rolling, which can lead to increased application times, uneven coverage, and potential quality issues. The thickness and evenness of coverage is dictated by strict safety and industrial quality standards, a hand applied coating job is labor intensive and difficult.

Some examples of prior systems include U.S. Pat. No. 6,666,301 owned by Urecoat Technologies, Inc., teaching a system mounted on a trailer of a flatbed semi-truck. It has a tank of one of the coating materials, the tank being heated by an internal heating system and a second material to be mixed with the first material in a static mixer unit. It also requires that the hose feeding the materials to the outlet valve/coupling be heated.

Another example is U.S. Pat. No. 7,963,719 to Wilson relating to a portable system for applying coating to surfaces, in which the coating materials do not require heating, so not a 100% solid component epoxy system. Very small volumes are being provided in a portable, “back-pack” style container. There is no compressor or power source provided.

A further example is U.S. Pat. No. 3,841,527 to von Roeschlaub relates to an applicator for a hot product like joint sealant. The material is heated using heating coils filled with a heating material and is stored in a tank. The dispensing hose also needs to be heated.

Other examples include US 2001/0030241 to Kott, which teaches a tanked system for supplying paint or coatings to spray a truck bed liner. Lines from each of the tanks are connected to the spray guns and pumps and a pump motor are used to pump coatings from the tanks through the lines to the spray gun.

A further example is U.S. Pat. No. 3,960,325 to Nienow which teaches a heating and spraying system for cold process roof material in which cold process roof material stored in a reservoir or barrel is pumped through lines into a heating kettle full of heat transfer medium. The cold process roof material passes through heating coils in the heating kettle to heat it and then pumped out of the kettle and to an airless nozzle.

Recently, cartridge-loaded spray guns have been introduced on the market for smaller jobs inside facilities, as opposed to the traditional configuration of using the spray bundle. Cartridge loaded-spray guns are loaded with a cartridge for each of the epoxy coating components, having a volume of from about 0.5 to 1 L each, but which can naturally vary. The spray gun can be hooked up to a source of compressed air to supply the hydraulic power needed for spraying; that is the spraying force. The cartridges of coating component must still be heated up to the required 50 to 60° C. One method presently being used, for example, is to heat the cartridges in a microwave to an approximate temperature, loading the heated cartridges into the spray gun, connect the spray gun to a compressed air source, then moving over to the substrate and applying the coating.

While use of spray guns can be seen in, for example, U.S. Pat. No. 6,533,189 for painting truck bed liners indoors at a painting facility, it uses, not a cartridge-loaded spray gun, but rather traditional tanks of coating components, the tanks being heated and temperature regulated. A compressor connected by a line to the spray gun supplies compressed air, with the compressor and tank pumps can be connected to a standard power source.

However, a need still exists in the plural component epoxy coating industry for a convenient means of taking advantage of the new cartridge spray guns such that they could replace the nozzle system traditionally used. The need also exists for the ability to use such spray guns in remote outdoor locations where temperatures can drop to well below 0° C. for outdoor work and for a way in which to use the spray guns such that the cartridges can replace the barrels or vats of coating components and heated, insulated hoses.

### SUMMARY

A tankless system is provided for use with one or more cartridge-style spray guns for coating pipelines and equipment in remote outdoor locations. The system includes a system case sized to fit into a back of a pickup truck. The system case includes an insulated and heated cartridge container for storing one or more coating or paint cartridges, an independent power source, an independent source of compressed air and a control panel to control power to the system, control and monitor temperature of the cartridge container and control and monitor operation of the source of compressed air. The system is tankless and all coating and paint is provided to the cartridge-style spray guns by the cartridges.

A method is also provided for performing painting and coating operations in a remote site using cartridge-style spray guns. The method includes the steps of transporting the system case as taught above, on the back of a pick-up truck, to the remote site, loading the one or more spray guns with cartridges from the heated container, connecting one or more cartridge-loaded spray guns to the source of compressed air and coating with the one or more cartridge-loaded spray guns, a surface to be coated.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

A further, detailed, description of the invention, briefly described above, will follow by reference to the following drawings of specific embodiments of the invention. The drawings depict only typical embodiments of the invention and are therefore not to be considered limiting of its scope. In the drawings:

FIG. 1 is a first perspective view of one example of a case for use with a system of the present invention;

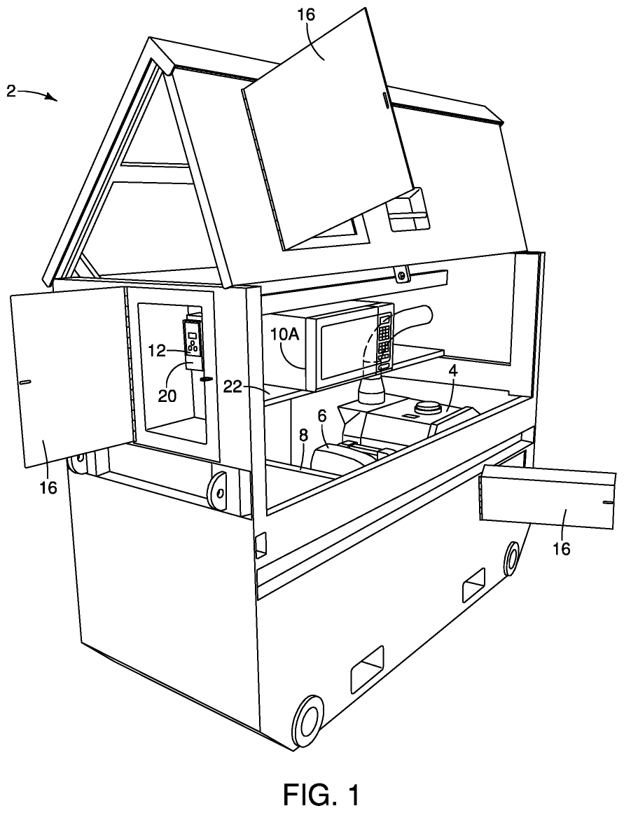

FIG. 2 is a second perspective view of the case of FIG. 1;

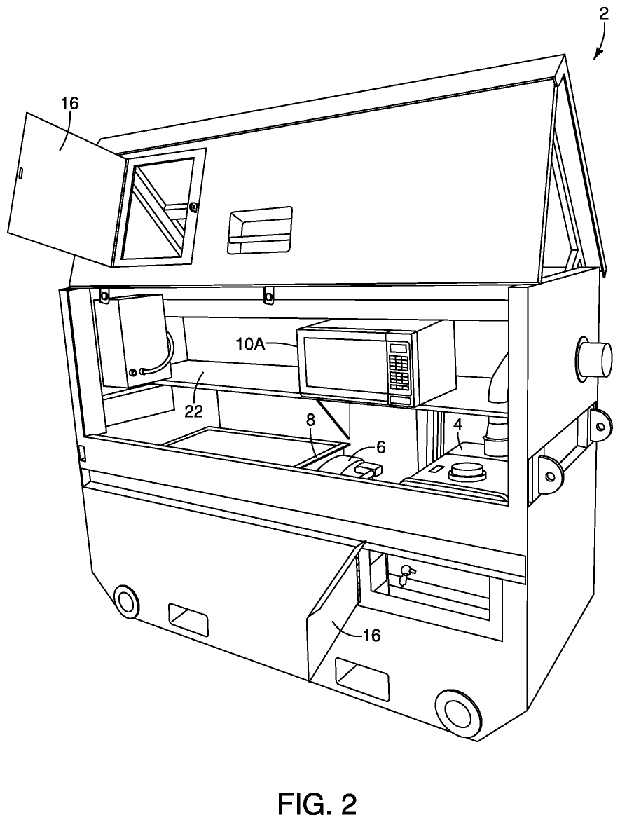

FIG. 3 is a front elevation view of one example of the system as contained in the case of FIG. 1;

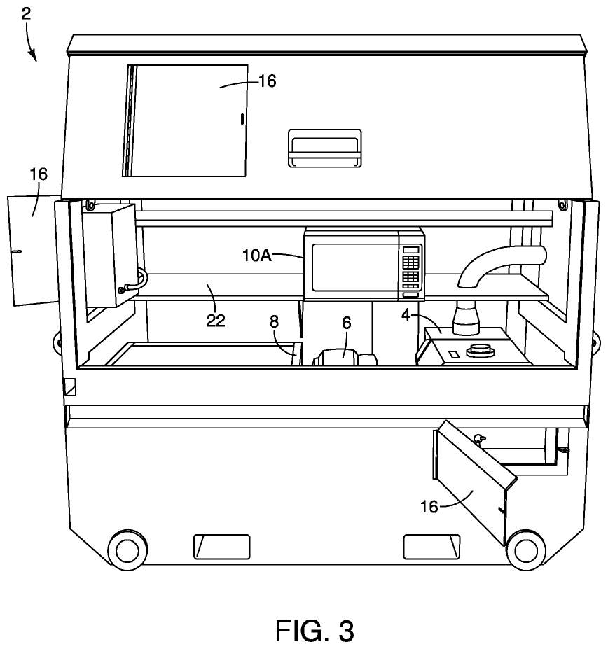

FIG. 4 is top plan view of the case of FIG. 1;

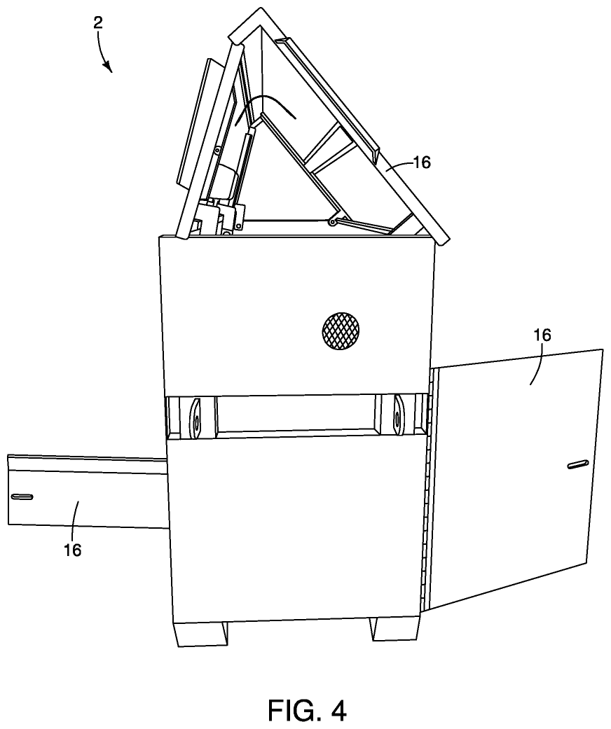

FIG. 5 is a perspective view of an interior of the system of FIG. 3;

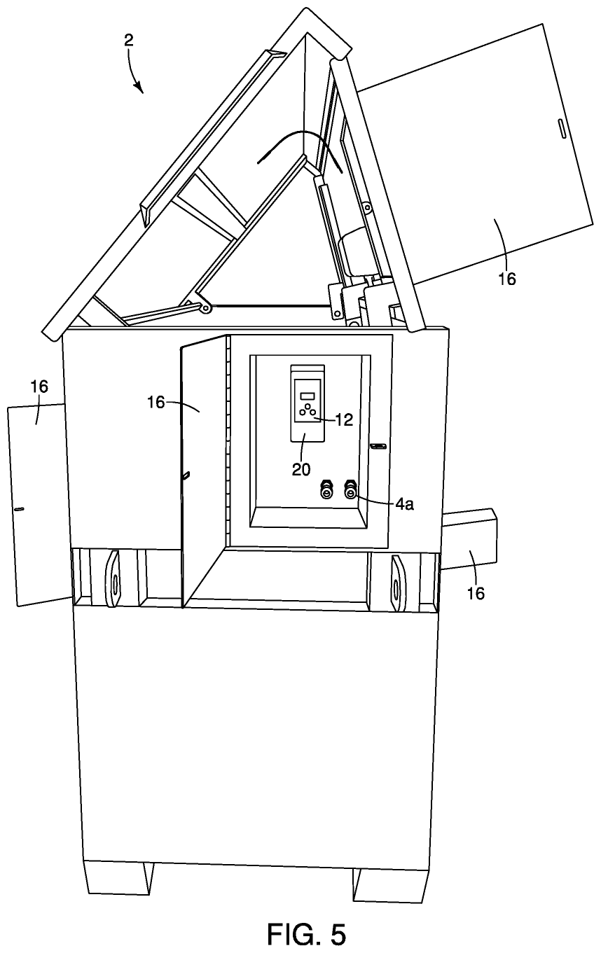

FIG. 6 is a perspective view of an interior of one example of the system of FIG. 3;

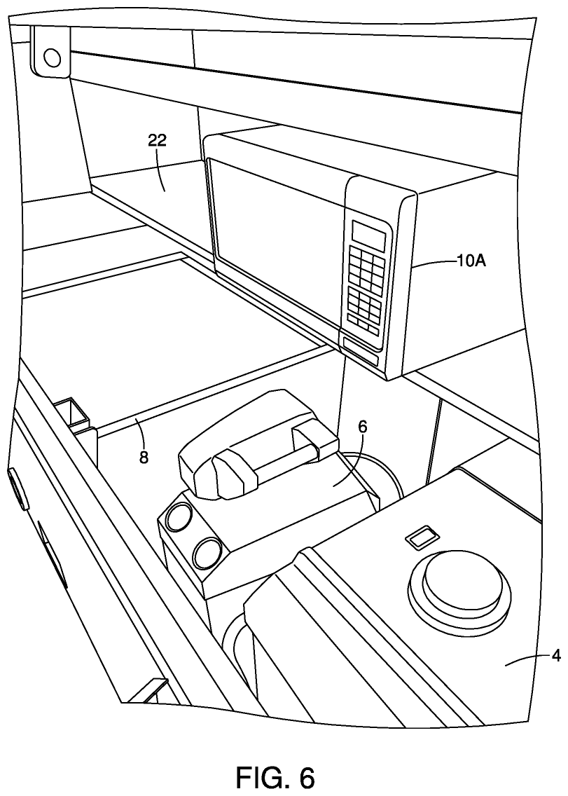

FIG. 7 is a close-up perspective view of an interior of one example of a heated cartridge container of the system; and

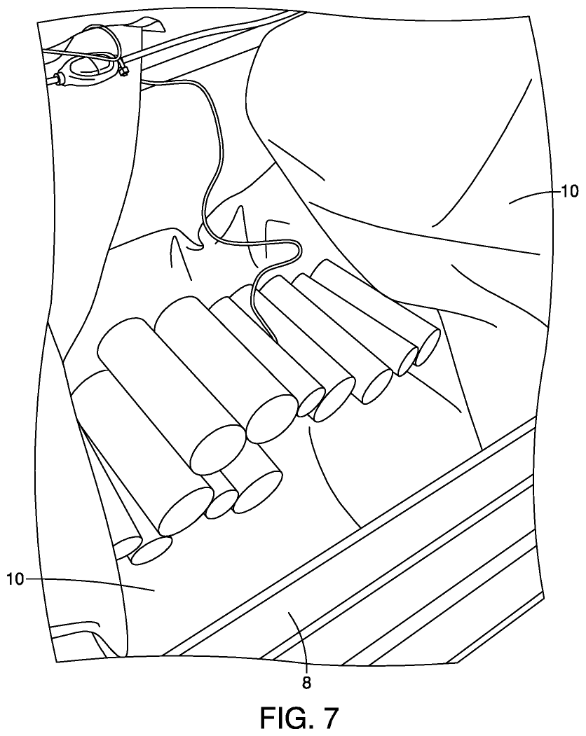

FIG. 8 is a third perspective view of the case of FIG. 1.

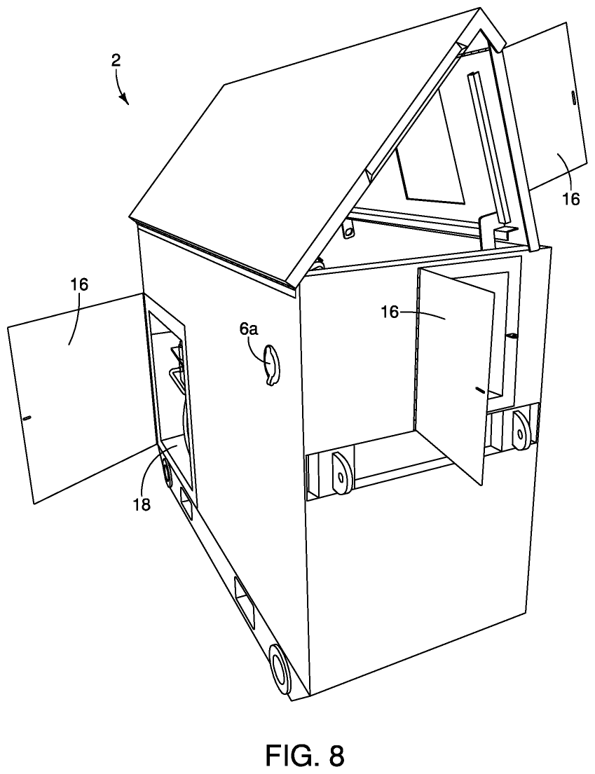

The drawings are not necessarily to scale and in some instances, proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

The present invention relates to a skid-mounted, tankless system for use with cartridge-loaded spray guns in remote, outdoor environments for painting or coating of both below ground and above grade applications. The present tankless system provides integration, sensing and automation of all the elements and sufficient coating needed to utilize cartridge-loaded spray guns for remote spray painting or coating operation. The system allows for the use of cartridge-loaded spray guns for painting or coating operations and avoids the need for transporting vats or tanks of paint or coating material.

The present tankless system comprises a system case that can be loaded on the back of a standard pick-up truck, hoisted by a crane or helicopter, or dragged on skids to remote locations and comprises its own compressed air, heating and power sources.

With reference to the attached Figures, the present tankless system 2 is self-contained within system case 14, said system case being transportable on the back of a pick-up truck such as a one-ton, ¾ ton, half-ton, midsize or compact pick-up truck.

The system case 14 contains a power source 4, preferably a generator, to power the various elements of the tankless system 2. The generator 4 can optionally also provide electrical power to any other painting or coating devices in the vicinity of the system 2 and that require power and are compatible with the generator's power output. The system case 14 also houses a compressor 6 to supply compressed air via one or more lines to the inlets of one or more cartridge-loaded spray guns. The compressor 6 is preferably sized to supply compressed air to more than one cartridge-style spray gun over a range of lengths of spray line distances. It is also possible to have more than one compressor 6 to provide compressed air capacity as needed. While the compressor 6 can handle most spray line lengths, since the present tankless system 2 is portable and compact, it can also be positioned much closer to equipment being painted or coated, than previous systems.

An insulated and heated cartridge container 8 can store multiple cartridges containing the painting or coating components. Cartridges for any number of types of painting or coating components for any number of types of painting or coating jobs can be stored in the cartridge container 8 and kept at a desired temperature, thereby making the system useable for multiple painting or coating products either at the same time or short succession.

In one preferred embodiment, the cartridge container 8 can be heated by means of one or more heating blankets 10 within the cartridge container 8, preferably lining the cartridge container 8, to heat cartridges to a predetermined temperature. The heating blankets 10 are preferably electrical and can be powered by the generator 4. The heating blankets 10 are more preferably connected to a thermostat 12 and control panel 20 on an external surface of the tankless system 2 to monitor and control the temperature inside the cartridge container 8. It is also possible to heat the cartridge container 8 by other means such as an electrical heater, heating coils of heated fluid, electrical heating coils and further such means as would be understood by a person of skill in the art. In such cases, it is only the cartridges within the cartridge container 8 that are heated, and there is no need for supplying or heating of a traditional hose bundle.

The control panel 20 of the present allows a single operator to control temperature, compressor 6 operation, and to turn the on or off. Remote operation of the is also possible by means of an application on any computer, tablet or smart phone, by which an operator can turn the on or off, and monitor and set the temperature of the heating container 8. In this way, the system 2 can be turned on and the cartridges heated or preheated before an operator arrives at site, so that the painting or coating operation can be conducted as soon as the operator arrives. Temperature monitoring of the cartridges of painting or coating components also allows for data logging to provide a record that painting and coating cartridges met temperature specifications when used. A GPS tracker can also be included on the tankless system 2 so that location of the tankless system 2 can be centrally tracked and monitored.

A number of preferable features can also be provided in the tankless system 2. In one example, the transportable system case 14 can be fitted with casters, wheels, lifting lugs, lifting eyes, skids etc., for ease of transport. As mentioned previously, the case 14 is sized for loading on the back of a pick-up truck and transported to a remote work site. In cases where road access is not available to a location requiring painting or coating, the system case 14 can be lifted by helicopter and transported with an operator to the painting or coating site. Only one operator is required to operate this tankless system 2.

Since the system 2 is tankless, the weight of the system case 14 and the components contained therein is significantly reduced from traditional systems that are hauled in large semi-trucks and are required to hold multiple large tanks of coating components.

One or more walls 24 of the case 14 are provided with one or more panel accesses 16 to one or more components of the tankless system 2. Further preferably the compressor 6 and generator 4 can be mounted on a sliding shelf 18 on which they can be easily removed or replaced in case repair or replacement is required.

The walls 24 of the case 14 can also include one or more external vents 26 to provide cooling to the compressor 6, generator 4 and other components to prevent overheating or fire hazard. These external vents 26 are illustrated along the sides of the case 14, although other locations of the external vents are also possible and encompassed by the scope of the present disclosure. A blower 28 may also be provided to promote air circulation through compartments of the system case 14 containing the compressor 6, generator 4, or other components.

A number of back-up components can also be stored in the case 14, such as a 110-volt power connection 4a to provide power should the generator 4 fail, an airline hook-up 6a to an external air compressor, should the system's compressor 6 fail, and a back-up heater 10a should the heating blanket 10 fail or not produce enough heat. In one example the back-up heater 10a can be a microwave stored in the case and powered either by the generator 4 or by an optional power connection. Storage 22 for one or more spray guns is also optionally provided.

In operation, the present tankless system 2 can be transported to a site for substrate painting or coating. As a portable tankless system 2, the system can be loaded on the back of a pick-up truck and be accommodated in tight access locations. The cartridge container 8 can be loaded with multiple cartridges of different types for different applications and for use in different spray guns. Heating of the cartridge container 8 can be initiated and maintained throughout transportation and at site, powered by the system's generator 4. Once at site, a single operator can check and adjust temperature inside the cartridge container 8 via the control panel 20. Cartridge-style spray guns, stored in the case 14 can be selected by the operator, loaded with the preheated cartridges, and connected to the air compressor 6. As mentioned, more than one cartridge-style spray gun is capable for use simultaneously with the present tankless system 2. Cartridges of the desired painting or coating components can then be loaded in the spray gun. No component lines, heating lines, pumps or insulated hose are required. The operator can now proceed with a painting or coating operation. In addition to painting or coating field welds and pipelines, repair jobs can be painted or coated using the present system, eliminating the need for manual mixing and brush on application of paint or coatings.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A tankless system for use with one or more cartridge-style spray guns for coating pipelines and equipment in remote outdoor locations, said system comprising:
a. a system case sized to fit into a back of a pickup truck said system case containing:
i. an insulated and heated cartridge container for storing one or more coating or paint cartridges;
ii. an independent power source;
iii. an independent source of compressed air; and
iv. a control panel to control power to the system, control and monitor temperature of the cartridge container and control and monitor operation of the source of compressed air.
wherein said system is tankless and all coating and paint is provided to the cartridge-style spray guns by the cartridges.

2. The system of claim 1, wherein the cartridge container is free from hoses or lines.

3. The tankless system of claim 1, wherein the system is remotely operable to turn the system on or off, monitor and set the temperature of the cartridge container and control operation of the source of compressed air.

4. The tankless system of claim 1, further comprising a GPS tracker for remote tracking of the location of the system from a central location.

5. The tankless system of claim 1, wherein the source of compressed air is an air compressor sized to supply compressed air to the one or more cartridge-style spray guns.

6. The tankless system of claim 5, wherein the air compressor is sized to provide compressed air over a range of lengths of spray line distances.

7. The tankless system of claim 1, wherein the system is portable and positionable proximal to equipment being painted or coated.

8. The tankless system of claim 1, wherein the insulated, heated cartridge container is heated by means of one or more heating blankets that form a lining within the container.

9. The tankless system of claim 8, wherein the one or more heating blankets are electrical and are powerable by the independent power source.

10. The tankless system of claim 1, wherein the system case comprises any one or more of casters, wheels, lifting lugs and skids for ease of transport.

11. The tankless system of claim 1, wherein the system case comprises one or more sliding shelves for supporting any one or more components of the system and for allowing ease of removal or replacement of said components.

12. The tankless system of claim 1, wherein one or more walls of said system case comprise one or more external vents to provide venting and cooling to any one or more of the components of the system case.

13. A method of performing painting and coating operations in a remote site using cartridge-style spray guns, said method comprising the steps of:
b. transporting the system case as taught in claim 1, on the back of a pick-up truck, to the remote site;
c. loading the one or more spray guns with cartridges from the heated container;
d. connecting one or more cartridge-loaded spray guns to the source of compressed air; and
e. coating with the one or more cartridge-loaded spray guns, a surface to be coated.

14. The method of claim 13, further comprising heating of the cartridge container throughout transportation such that the cartridges are at a predetermined temperature when the system case reaches the remote site.

15. The method of claim 13, further comprising remotely turning the system on or off, monitoring and setting temperature of the cartridge container and remotely operating source of compressed air.

16. The method of claim 13, further comprising, monitoring temperature of the paint or coating cartridges and logging temperature data to provide a record paint and coating cartridges temperatures at use.
